(19) United States
(12) Patent Application Publication
(10) Pub. No.: US 2008/0268700 A1
(43) Pub. Date: Oct. 30, 2008

(54) Electronic device connector system

(76) Inventors: Thomas P. Sawyers, Hempstead, TX (US); Qijun Chen, Spring, TX (US); Earl W. Moore, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,401

(22) Filed: Apr. 30, 2007

(51) Int. Cl. H01R 3/00

(52) U.S. Cl. 439/500

(57) ABSTRACT

An electronic device connector system, comprising a connector member having a plurality of spaced-apart conductive inserts, at least one of the plurality of spaced-apart inserts comprising a plurality of separate conductor portions.

### BACKGROUND

Electronic devices, such as laptop or notebook computers, comprise detachable battery housings having connector systems to facilitate transfer of power and data signals. Such connector systems comprise corresponding connectors that are assembled by inserting conductive inserts into standard pitch slots. Each conductive insert is configured to carry a signal such as, for example, a power signal or a data signal. However, in the event additional power and/or signal communication paths are necessary, the connector members, and its housing, must be modified to increase the width thereof to accommodate additional slots and inserts. Due to the limited amount of available space within battery housings and notebook computers, incorporating wider connector members is problematic.

### BRIEF DESCRIPTION OF THE DRAWINGS

FIG. 1 is a diagram of an electronic device in which an embodiment of a connector system is employed to advantage;

FIG. 2 is a diagram illustrating a partial exploded view of the connector system of FIG. 1;

FIG. 3A is a diagram illustrating a pair of inserts of the connector system of FIGS. 1 and 2; and

FIG. 3B is a diagram illustrating another embodiment of a pair of inserts of the connector system of FIGS. 1 and 2.

### DETAILED DESCRIPTION OF THE DRAWINGS

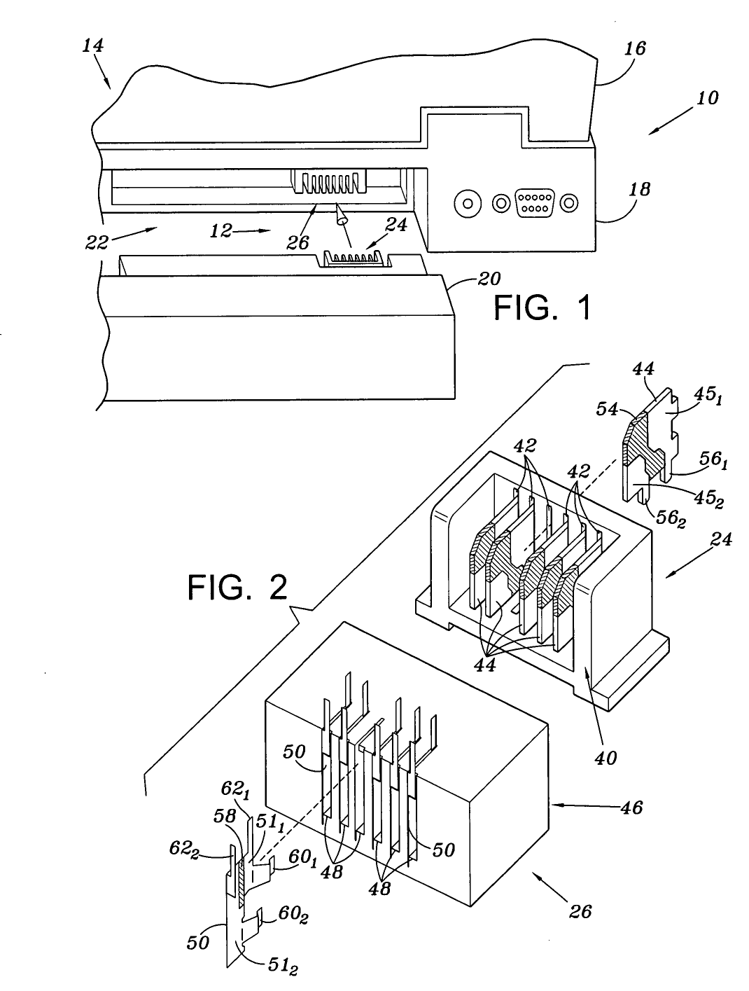

FIG. 1 is a diagram illustrating an electronic device 10 in which an embodiment of a connector system 12 is employed to advantage. In the embodiment illustrated in FIG. 1, electronic device 10 comprises a laptop or notebook computer 14; however, it should be understood that electronic device 10 may comprise any type of electronic device such as, but not limited to, a tablet personal computer, a personal digital assistant, a gaming device, or any other type of portable or non-portable electronic device. In the embodiment illustrated in FIG. 1, electronic device 10 comprises a display member 16 coupled to a base member 18. In the embodiment illustrated in FIG. 1, electronic device 10 comprises a battery 20 insertible within a battery bay 22 of base member 18; however, it should be understood that battery bay 22 may be otherwise located (e.g., at any location on display member 16).

In the embodiment illustrated in FIG. 1, connector system 12 comprises a connector member 24 disposed on battery 20 and a corresponding connector member 26 disposed within battery bay 22 communicatively engageable to facilitate the transfer of power and data signals. For example, in the embodiment illustrated in FIG. 1, connector system 12 facilitates the transfer of high current signals, such as a power signal and a ground signal, while also facilitating the transfer of low current signals, such as one or more data signals, to enable battery 20 to transmit information to electronic device 10 such as, but not limited to, battery status information, voltage values, current values, temperature values, etc.

FIG. 2 is a diagram illustrating a partial exploded view of connector system 12 of FIG. 1. In the embodiment illustrated in FIG. 2, connector member 24 comprises a housing 40 having a plurality of spaced-apart slots 42 each configured to receive and support a spaced-apart insert 44. Connector member 26 comprises a housing 46 having a plurality spaced-apart slots 48 each configured to receive and support a spaced-apart insert 50. In the embodiment illustrated in FIG. 2, one or more inserts 44 and 50 are configured to each transmit a plurality of signals to facilitate the manufacture of connectors with fewer slots, and thus smaller in size, and/or to facilitate the manufacture of connectors having a greater signal carrying capacity without modifications to housings 40 and 46 (e.g., widening housings 40 and 46 to accommodate additional inserts).

In FIG. 2, in some embodiments, inserts 44 and 50 are removably coupleable to housings 40 and 46 to facilitate interchangeability of inserts 44 and 50 with different sizes and/or types of inserts and/or for maintenance or repair of inserts without requiring modification of housings 40 and/or 46. According to some embodiments, inserts 44 and 50 are secured within housings 40 and 46 by frictional engagement; however, it should be understood that other methods of securing inserts 44 and 50 within housings 40 and 46 may be used (e.g., using an adhesive, snapping in place, soldering, etc.). In the embodiment illustrated in FIGS. 1 and 2, connector 24 is disposed within battery 20 and connector 26 is disposed within electronic device 10; however, it should be understood that connectors 24 and 26 may be otherwise disposed (e.g., connector 24 disposed within electronic device 10 and connector 26 disposed within battery 20). In FIG. 2, housings 40 and 46 comprise six spaced-apart slots 42 and 48 configured to receive inserts 44 and 50, respectively; however, it should be understood that housings 40 and 46 may be otherwise manufactured with a greater or fewer number of slots 40 and 46 and corresponding inserts 44 and 50, respectively.

In the embodiment illustrated in FIG. 2, insert 44 comprises an insulator portion 54 configured to form at least two separated/and or discrete conductor portions 45₁ and 45₂ on insert 44. In the embodiment illustrated in FIG. 2, two conductor portions 45₁ and 45₂ are illustrated; however, it should be understood that a greater or fewer number of conductor portions 45 may be utilized. In FIG. 2, each conductor portion 45₁ and 45₂ comprises at least one lead 56₁ and 56₂, respectively, to couple conductor portions 45₁ and 45₂ to a printed circuit board disposed within battery 20. In FIG. 2, each conductor portion 45₁ and 45₂ is configured to carry a separate signal. For example, conductor portion 45₁ may be rated for a six amp current capacity for transferring power to electronic device 10 while conductor portion 45₂ may be rated for a 0.1 amp current capacity to facilitate transfer of data signals to electronic device 10. It should be understood that each insert 44 may be otherwise configured. For example, in the embodiment illustrated in FIG. 2, a particular insert may comprise a conductor portion 45₁ rated for three amp current capacity and a conductor portion 45₂ rated for a 0.5 amp current capacity, while another insert 44 disposed within housing 40 may comprise conductor portions 45₁ and 45₂ rated for a 0.5 current capacity and a 0.2 amp current capacity, respectively. In other embodiments, it should be understood that one or more of inserts 44 may comprise a single conductor portion 45, rated to for a single current capacity (e.g., a seven amp current capacity).

In the embodiment illustrated in FIG. 2, one or more inserts 50 each comprise plurality of conductor portions 51₁ and 51₂ separated by an insulator 58. In the embodiment illustrated in FIG. 2, two conductor portions 51₁ and 51₂ are illustrated; however, it should be understood that a greater or fewer number of conductor portions 51₁ and 51₂ may be utilized on insert 50 so as to correspond to an insert 44 disposed within connector housing 40. In FIG. 2, conductor portions 51₁ and 51₂ each comprise a finger 60₁ and 60₂ outwardly extending from conductor portions 51₁ and 51₂, respectively, such that when connectors 24 and 26 are communicatively coupled together, fingers 60₁ and 60₂ contact conductors 45₁ and 45₂ on insert 44, respectively, to facilitate communicative engagement between inserts 44 and 50. In the embodiment illustrated in FIG. 2, conductors 51₁ and 51₂ each comprise a lead 62₁ and 62₂, respectively, for communicatively coupling insert 50 to a printed circuit board disposed within electronic device 10. In the embodiment illustrated in FIG. 2, conductor portions 51₁ and 51₂ are rated to transfer signals corresponding to a set of corresponding conductor portions 45₁ and 45₂. For example, in the event conductor portions 45₁ and 45₂ are rated for a 0.5 current capacity and a 0.2 amp current capacity, respectively, conductor portions 51₁ and 51₂ are rated to at least carry a 0.5 current capacity and a 0.2 amp current capacity, respectively.

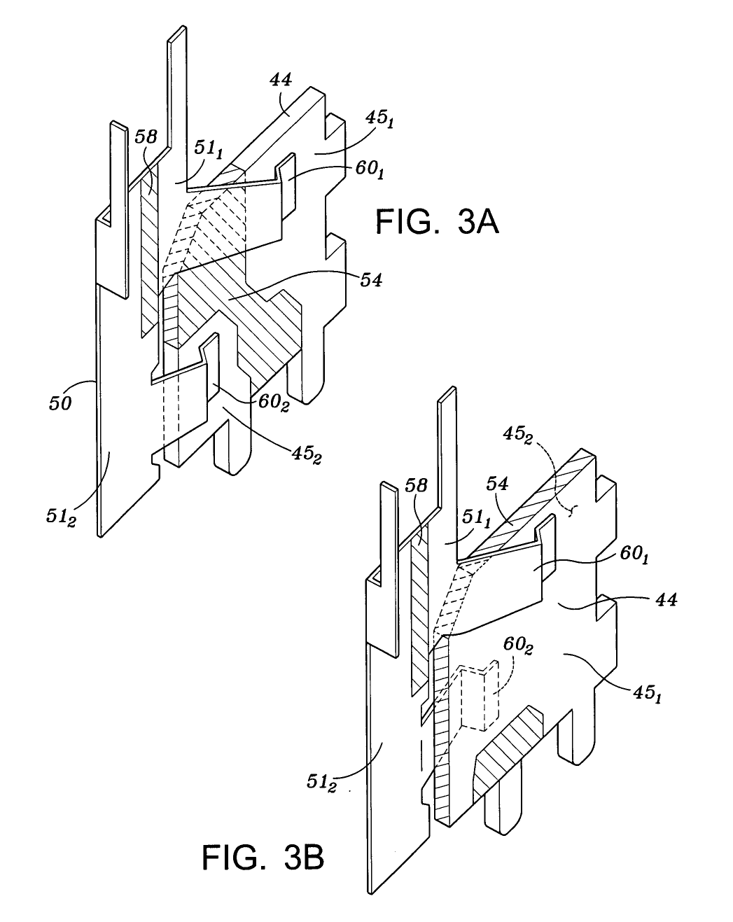

FIG. 3A is a diagram illustrating inserts 44 and 50 of connector system 12 of FIGS. 1 and 2. In the embodiment illustrated in FIG. 3A, inserts 44 and 50 are configured such that finger 60₁ is positioned to contact conductor portion 45₁. Thus, during operation, current travels between battery 20 to electronic device 10 via finger 60₁ so as to communicatively engage conductor portion 51₁ on insert 50. Similarly, a different current travels between battery 20 to electronic device 10 via finger 60₂ so as to communicatively engage conductor portion 51₂ on insert 50.

FIG. 3B is a diagram illustrating another embodiment of inserts 44 and 50 of connector system 12 of FIGS. 1 and 2. In the embodiment illustrated in FIG. 3B, insert 44 comprises insulator 54 sandwiched between conductors 45₁ and 45₂ forming a multi-layer insert 44 to isolate conductors 45₁ and 45₂. Thus, insert 44 is aligned with and inserted between fingers 60₁ and 60₂ to facilitate contact between fingers 60₁ and 60₂ with conductors 45₁ and 45₂ to enable communicative contact between inserts 44 and 50.

According to some embodiments, inserts 44 and 50 are formed of a metal, copper or any other type of conductive material; however, it should be understood that inserts 44 and/or 50 may be otherwise configured. For example, inserts 44 and/or 50 may be formed of a plastic material coated with a conductive substance (e.g., copper), formed from a plastic material with separate conductors coupled thereto, etc.

Embodiments of a connector system 12 can be manufacturing by providing a connector member having a plurality of inserts, at least one of the plurality of inserts comprising a plurality of separate conductor portions. The connector system 12 may also be manufactured by providing an insulator portion separating the plurality of conductors. The connector system 12 may also be manufactured by sandwiching a conductor between the plurality of conductors. The connector system 12 may also be manufactured by providing a plurality of corresponding inserts disposed on another connector member, at least one of the plurality of corresponding inserts comprising a plurality of separate conductor portions for communicative engagement with the at least one of the plurality of inserts. The connector system 12 may also be manufactured by providing a plurality of fingers on the plurality of corresponding inserts for communicative engagement with the at least one of the plurality of inserts.

Thus, embodiments of a connector system 12 can be manufactured having inserts 44 and 50 having a plurality of conductors 45₁, 45₂, and 51₁, 51₂ respectively, configured to carry at least two different currents. Furthermore, embodiments of connector system 12 are manufactured to enable easy interchangeability of inserts 44 and 50 in connector system 12.

1. An electronic device connector system, comprising:
a connector member having a plurality of spaced-apart conductive inserts, at least one of the plurality of spaced-apart inserts comprising a plurality of separate conductor portions, at least one of the conductor portions having a current capacity different than another of the conductor portions.

2. The system of claim 1, wherein the at least one of the plurality of spaced-apart inserts comprises an insulator portion separating the plurality of conductor portions.

3. The system of claim 1, wherein the at least one of the plurality of spaced-apart inserts comprises an insulator portion sandwiched between the plurality of conductor portions.

4. The system of claim 1, further comprising a plurality of corresponding inserts disposed on another connector member, at least one of the plurality of corresponding inserts comprising a plurality of separate conductor portions for communicative engagement with the at least one of the plurality of inserts.

5. The system of claim 4, wherein the at least one of the plurality of corresponding inserts comprises a plurality of fingers for communicative engagement with the at least one of the plurality of spaced-apart inserts.

6. A method of manufacturing an electronic device connector system, comprising:
providing a connector member having a plurality of spaced-apart inserts, at least one of the plurality of spaced inserts comprising a plurality of separate conductor portions, at least one of the conductor portions having a current capacity different than another of the conductor portions.

7. The method of claim 6, further comprising providing an insulator portion separating the plurality of conductor portions.

8. The method of claim 6, further comprising sandwiching a conductor between the plurality of conductor portions.

9. The method of claim 6, further comprising providing a plurality of corresponding inserts disposed on another connector member, at least one of the plurality of corresponding inserts comprising a plurality of separate conductor portions for communicative engagement with the at least one of the plurality of inserts.

10. The method of claim 9, further comprising providing a plurality of fingers on the plurality of corresponding inserts for communicative engagement with the at least one of the plurality of spaced-apart inserts.

11. An electronic device connector system, comprising:
a connector means having a plurality of spaced-apart insert means, at least one of the plurality of spaced-apart insert means comprising a plurality of separate conductor means, at least one of the conductor means having a current capacity different than another of the conductor means.

12. The system of claim 11, wherein the at least one of the plurality of spaced-apart insert means comprises an insulator means separating the plurality of conductors means.

13. The system of claim 11, wherein the at least one of the plurality of spaced-apart insert means comprises a conductor means sandwiched between the plurality of conductor means.

14. The system of claim 11, further comprising a plurality of corresponding insert means disposed on another connector means, at least one of the plurality of corresponding insert means comprising a plurality of separate conductor means for communicative engagement with the at least one of the plurality of spaced-apart insert means.

15. The system of claim 14, wherein the at least one of the plurality of corresponding insert means comprises a plurality of fingers means for communicative engagement with the at least one of the plurality of spaced-apart insert means.

16. The system of claim 1, wherein the conductor portions of laterally adjacent ones of the conductive inserts are vertically aligned with each other when the conductive inserts are disposed within the connector member.

17. The system of claim 6, further comprising vertically aligning the conductor portions of laterally adjacent ones of the conductive inserts disposed within the connector member.

18. The system of claim 11, wherein the conductor means of laterally adjacent ones of the insert means are vertically aligned with each other when the insert means are disposed within the connector means.

19. The system of claim 1, wherein each lead from the conductor portions of the conductive insert have a same length.

20. The system of claim 11, wherein each lead from the conductor means of the insert means have a same length.
